(19) United States
(12) Patent Application Publication
(10) Pub. No.: US 2024/0216868 A1
(43) Pub. Date: Jul. 4, 2024

(54) SYSTEM FOR MONITORING A FLUID AND CONTROLLING A PROCESS IN A MEMBRANE FILTRATION PLANT

(71) Applicant: GEA Liquid Technologies A/S, Skanderborg (DK)

(72) Inventor: David Parbo Mikkelsen, Søborg (DK)

(73) Assignee: GEA Process Engineering A/S, Søborg (DK)

(21) Appl. No.: 18/570,895

(22) PCT Filed: Jun. 18, 2021
(86) PCT No.: PCT/DK2021/050197

§ 371 Date: Dec. 15, 2023

(51) Int. Cl. B01D 65/02; B01D 61/12; B01D 61/22

(52) U.S. Cl. CPC B01D 65/02; B01D 61/12; B01D 61/22; B01D 2321/02; B01D 2321/40

(57) ABSTRACT

A system for monitoring a fluid and controlling a process in a membrane filtration plant is provided herein. The system comprises includes a feed sensor, a downstream sensor, and a controller.

### TECHNICAL FIELD

The present invention relates to a system for monitoring a fluid and controlling a process in a membrane filtration plant, a membrane filtration plant comprising such a system, and a method implemented by a controller for monitoring a fluid and controlling a process in a membrane filtration plant.

### BACKGROUND ART

Membrane filtration plants are widely used around the world for a plurality of purposes, such as the removal of bacteria, microorganisms, or particulates from a fluid to achieve a desired result. Membrane filtration plants are furthermore used within a wide field of industries such as the dairy industry, food and beverage industry, fermentation and biotechnology industry, chemical industries and in wastewater applications.

With the wide deployment and usage of membrane filtration plants there is a constant thrive for improving the performance of the membrane filtration plants, as even a small improvement may lead to a large return both financially, but also in regard to the environmental impact the membrane filtration plants have.

Especially, the field of process control is attractive to look into, since by optimising processes the amount waste and/or downtime resulting from the processes may be reduced, thus lessening the environmental impact, without having to deploy a range of additional process equipment to the membrane filtration plant.

Solutions trying to achieve the above have already been tried, for example WO 2014/044600 A1 discloses an apparatus for detecting a transition from a first phase to a second phase in a processing line. The apparatus comprises a first sensor for gathering data indicating product concentration, a second sensor for gathering data indicating product concentration. The first sensor is placed upstream said second sensor. Further, the apparatus comprises a control device configured to receive a first data set from said first sensor and a second data set from said second sensor, and to calibrate said second sensor by comparing said second data set with said first data set.

Even though solutions have been presented for optimising processes, there is still a need for a solution for optimising a process, especially a solution directly targeted towards membrane filtrations plants.

### SUMMARY OF THE INVENTION

It is an object of the present invention to provide an improved system for monitoring a fluid in a membrane filtration plant, and to provide a system, which overcomes or at least alleviates the problems of the prior art.

In a first aspect of the invention, this and further objects are achieved with a system for monitoring a fluid and controlling a process in a membrane filtration plant, wherein the system comprises:
a downstream sensor configured for obtaining downstream data regarding a characteristic of a permeate or a retentate of the membrane filtration plant, and
a controller communicatively connected to the downstream sensor and configured to:
receive feed data regarding a characteristic of a feed of the membrane filtration plant,
determine, based on the received feed data, the characteristic of the feed,
receive downstream data from the downstream sensor,
determine, based on the received downstream data, the characteristic of the permeate or the retentate,
compare the characteristic of the feed with the characteristic of the permeate or the retentate to determine a downstream difference between the characteristic of the feed and the characteristic of the permeate or the retentate, and
compare the downstream difference with a downstream threshold,
control a process of the membrane filtration plant based on whether the downstream difference has exceeded the downstream threshold.

Consequently, a simple and efficient solution is achieved for both monitoring and controlling a process in a membrane filtration plant. By comparing upstream data, i.e. characteristic of the feed, with downstream data, i.e. characteristic of the permeate or retentate, a good measure of how far a process has progressed is achieved by the level of the downstream difference in itself. By further comparing the downstream difference with the downstream threshold, it is also rendered possible to provide fully automated control. For example, if the membrane filtration plant is undergoing a product switch, e.g. switching from orange juice to apple juice, then monitoring upstream data and downstream data and comparing these to each other gives a measure for whether the product switch has been completed or is still underway, hence allowing the process of the product switching to be controlled more efficiently. In the context of this disclosure the term fluid is to be interpreted broadly. For example, a fluid in the context of this disclosure also encompasses suspensions, mixtures of solids and liquids, mixtures of solids and gasses, an emulsion, an aerosol, etc.

In the context of this disclosure the term characteristic is to be interpreted broadly. A characteristic may be a physical characteristic of a fluid. A characteristic may be the density, the turbidity, the conductivity, or the viscosity of a fluid.

In the context of this disclosure the term feed is to be interpreted broadly. A feed may be any fluid which is introduced into the membrane filtrate plant and has not passed a membrane. The feed may be water, or a product such as juice, or a dairy product.

In the context of this disclosure the term retentate is to be interpreted broadly. A retentate may be any fluid which is introduced into the membrane filtrate plant and has passed a membrane without being filtered through the membrane. The retentate may be water, or a product such as juice, or a dairy product.

In the context of this disclosure the term permeate is to be interpreted broadly. A permeate may be any fluid which is introduced into the membrane filtrate plant and has passed a membrane and been filtered through the membrane. The permeate may be water, or a product such as juice, or a dairy product.

Whether the downstream sensor is arranged to measure on the permeate or the retentate may be highly dependent on the membrane filtration plant in which the system is deployed. If the system is deployed in conjunction with membranes with larger open pores such as microfiltration (MF) or ultrafiltration (UF) membranes, the downstream sensor may be arranged to measure either on the retentate or the permeate, as the fluid passing through the MF or UF membrane will be relatively similar to the feed fluid as only larger contaminants are filtered away. This is especially the case in water flush in which no major differences should be present between the permeate and the feed when the flush has been carried out. However, if the system is deployed in conjunction with membranes with smaller pores such as reverse osmosis (RO) or nanofiltration (NF) membranes, the downstream sensor may preferably be arranged to measure on the retentate, as the fluid which have passed through the membrane may be quite different from the feed fluid, as ions or other smaller particles may be filtered away by the membrane, thus even if the system has been flushed correctly there may still be a difference between the permeate and the feed. However, the threshold may be set-up to account for the membrane type, thus allowing for a permeate sensor to be used in conjunction with RO or NF membranes. The downstream difference may be determined as a difference in a characteristic between the feed and the permeate or the retentate, dependent on what the downstream sensor is arranged to obtain data regarding.

The comparison between the downstream difference and the downstream threshold is carried out to determine whether the downstream difference has exceeded the downstream threshold. The determination regarding whether the downstream difference has exceeded the downstream threshold may be carried out by determining if the downstream difference is within the downstream threshold, or outside the downstream threshold. The downstream threshold may be a maximum value for the downstream difference. The downstream threshold may be a minimum value for the downstream difference. The downstream threshold may be a range of allowable values for the downstream difference. The downstream threshold may be a range of unallowable values for the downstream difference.

The downstream sensor may be any sensor able to obtain data regarding a characteristic of a fluid. The downstream sensor may be an invasive sensor or a non-invasive sensor. Preferably, the downstream sensor is mountable on a process line. Alternatively, the downstream sensor may be mountable to a tank for collecting either a retentate or a permeate.

The controller is a unit comprising any circuit and/or device suitably adapted to perform the functions described herein. The controller may comprise general purpose or proprietary programmable microprocessors, such as Digital Signal Processors (DSP), Application Specific Integrated Circuits (ASIC), Programmable Logic Arrays (PLA), Field Programmable Gate Arrays (FPGA), special-purpose electronic circuits, etc., or a combination thereof. The controller may be communicatively connected to a display allowing the controller to display data and/or signals received from sensors. The controller may either directly control the process. The controller may control the process indirectly via sending one or more instructions to a central controller.

The controller may receive the feed data via an input given manually by personnel. The controller may receive the feed data via a feed sensor configured to obtain data regarding a feed of the membrane filtration plant. The feed data may be obtained by a measurement carried out by personnel which is then inputted to the controller. The feed data may be a pre-set value inputted to the controller. The pre-set value may be based on a measurement carried out on the feed, or general know-how.

The determination of the characteristic of the feed may be carried out by directly reading the characteristic of the feed from the received feed data. The determination of the characteristic of the feed may be carried out by processing the received feed data.

The determination of the characteristic of the retentate or permeate may be carried out by directly reading the characteristic of the retentate or permeate from the received downstream data. The determination of the characteristic of the retentate or the permeate may be carried out by processing the received downstream data.

The downstream difference may be determined as an absolute difference between the characteristic of the feed and the retentate or the permeate. The downstream difference may be determined as a relative difference between the characteristic of the feed and the retentate or the permeate.

The downstream threshold may be highly dependent on the format of the retentate or permeate and feed data. For example, if the feed data and the retentate data are given as conductivity measurements, the downstream threshold may be set to 0 mS-5 mS. If the feed sensor and the retentate sensor are temperature sensors, the downstream threshold may be set to 0 K-2 K.

The control of a process may comprise controlling the operation of one or more pumps associated with the membrane filtration plant. The control of a process may comprise controlling the operation of one or more valves associated with the membrane filtration plant.

In an embodiment the system further comprises a feed sensor configured for obtaining feed data regarding a characteristic of a feed of the membrane filtration plant, wherein the feed sensor is communicatively connected to the controller, and the controller is further configured to:
receive feed data from the feed sensor.

Consequently, the feed data may be obtained in real-time, thus allowing for more precise data regarding the feed to be obtained, as compared to relying on a previous carried out measurement. Furthermore, since both the feed and the retentate or permeate are monitored it is not required to have extensive knowledge of, or requirements to, the process fluid before using it for the process. Consequently, if a water flush is carried out with a different water source, e.g. switching from water from a water tank to ground water, the system will take this into account by continuously monitoring the feed fluid.

The feed sensor may be any sensor able to obtain data regarding a characteristic of a fluid. The feed sensor may be an invasive sensor or a non-invasive sensor. Preferably, the feed sensor is mountable on a process line. Alternatively, the feed sensor may be mountable to a feed tank.

In an embodiment the process is a flush.

Being able to precisely monitor and control a flush may allow for an improved management of the fluid used for flushing.

The flush may be a water flush where water is flushed through the membrane filtration plant. The flush may be a product flush where a product is flushed through the membrane filtration plant. The flush may be a cleaning flush where a cleaning fluid is flushed through the membrane filtration plant. The cleaning fluid may be part of a cleaning in place (CIP) process. The flush may be a water flush which is part of a cleaning process, where water is used for flushing out product remains or leftover cleaning fluid.

In an embodiment the controller is further configured to:
stop the flush when the downstream difference has exceeded the retentate threshold.

Consequently, a high level of fluid management may be achieved for the fluid used for flushing. Currently, conventional flushing process relies on predetermined flushing times to ensure the desired result, however the predetermined flushing times are set with a high margin of safety, thus resulting in conventional flushing processes continuing for a while, even when the desired result has been reached. With the presented solution the waste of fluid may be avoided by actively measuring on the fluid and stopping the process when the desired result has been reached, consequently, limiting wastage of the flushing fluid.

In an embodiment the flush is at least carried out for a minimum flush time, and wherein the controller is further configured to:
determine whether the minimum flush time has passed,
stop, if the minimum flush time has passed, the flush when the downstream difference has exceeded the downstream threshold.

Consequently, a margin of safety is added to the control of the process, thus even if the sensors or the controller of the system has an issue, the membrane filtration plant will still be flushed to a certain degree. Furthermore, most issues are normally experienced during the start of the flush, thus by having the minimum flush time in place the issues experienced during the start-up will not lead to unwanted effects.

The minimum flush time may be dependent on the membrane filtration plant. The minimum flush time may be given as an input to the controller by personnel of the membrane filtration plant. The minimum flush time may be dependent on a size or a product of the membrane filtration plant. The minimum flush time may be dependent on an amount of loops the membrane filtration plant comprises, e.g. each loop may have a minimum loop flush time associated with the loop. The minimum loop flush time may for example be 30 s-180 s dependent on the size of the loop.

In an embodiment the process is maximumly carried out for a maximum flush time, and wherein the controller is further configured to:
determine whether the maximum flush time has passed,
stop, if the maximum flush time has passed, the flush.

Consequently, an error in the controller or the sensors will not result in the system just continuing the flush indefinitely. Furthermore, in some cases there might even be an error in the membrane filtration plant, which will result in the downstream difference never reaching the downstream threshold, thus by implementing the maximum flush time errors in the membrane filtration plant will not result in an indefinite flush.

The maximum flush time may be dependent on the membrane filtration plant. The maximum flush time may be given as an input to the controller by personnel of the membrane filtration plant. The maximum flush time may be dependent on a size or a product of the membrane filtration plant. The maximum flush time may be dependent on an amount of loops the membrane filtration plant comprises, e.g. each loop may have a maximum loop flush time. The maximum loop flush time may for example be 40 s-500 s dependent on the size of the loop

In an embodiment the downstream sensor is a retentate sensor configured for obtaining downstream data regarding a characteristic of the retentate of the membrane filtration plant.

In an embodiment the membrane filtration plant comprises one or more loops each comprising a membrane for filtering the feed and a pump for circulating feed in the associated loop, wherein the system further comprises:
one or more permeate sensors communicatively connected to the controller and configured for obtaining permeate data regarding a characteristic of a permeate through the one or more membranes, and
wherein the controller is further configured to:
receive permeate data from the one or more permeate sensors,
determine, based on the received permeate data, the one or more characteristics of the permeate through the one or more membranes,
compare the characteristic of the feed with the one or more characteristics of the permeate to determine one or more permeate differences between the characteristic of the feed and the characteristic of the retentate, and
compare the one or more permeate differences with a permeate threshold,
control the process of the membrane filtration plant based on whether the one or more permeate differences has exceeded the permeate threshold.

Consequently, the process may be controlled based on both the permeate and the retentate. This is especially advantageous for membrane filtration plants comprising one or more loops, as the retentate may not be a good measure for how the process has progressed within the one or more loops, whereas the permeate may give a better measure for how the process has progressed within the one or more loops.

Preferably, the controller is configured to firstly control the process based on whether the one or more permeate differences has exceeded the permeate threshold, and then subsequently control the process based on whether the retentate difference has exceeded the retentate threshold.

The comparison between the permeate difference and the permeate threshold is carried out to determine whether the permeate difference has exceeded the permeate threshold. The determination regarding whether the permeate difference has exceeded the permeate threshold may be carried out by determining if the permeate difference is within the permeate threshold, or outside the permeate threshold. The permeate threshold may be a maximum value for the permeate difference. The permeate threshold may be a minimum value for the permeate difference. The permeate threshold may be a range of allowable values for the permeate difference. The permeate threshold may be a range of unallowable values for the permeate difference. In cases where the system comprises both a permeate sensor and a retentate sensor the threshold associated with the collected sensor data may differ between the permeate sensor and the retentate sensor, alternatively the threshold associated with the collected sensor data may be identical for the permeate sensor and the retentate sensor.

Having both a permeate sensor and a retentate sensor may allow for very precise control of an ongoing process, where the permeate sensor gives insight to progress within a loop of the membrane filtration plant, and the retentate sensor may give an insight into the overall progress within the membrane filtration plant.

In an embodiment the membrane filtration plant comprises a first loop comprising a first membrane for filtering the feed and a first pump for circulating feed in the first loop, wherein the system further comprises:
a first permeate sensor communicatively connected to the controller and configured for obtaining permeate data regarding a characteristic of a permeate through the first membrane, and wherein the controller is further configured to:
   A. control the first pump to flush the first loop,
   B. receive permeate data from the first permeate sensor,
   C. determine, based on the received permeate data, the characteristic of the permeate through the first membrane,
   D. compare the characteristic of the feed with the characteristic of the permeate through the first membrane to determine a first permeate differences between the characteristic of the feed and the characteristic of the permeate through the first membrane, and
   E. compare the first permeate differences with the permeate threshold,
   F. control the first pump to stop flushing the first loop based on whether the first permeate differences has exceeded the permeate threshold.

Consequently, a precise control of flushing of the membrane filtration plant is achieved, where flushing of the loop is also controlled.

The control of the first pump may comprise stopping the first pump, or lowering the powering output from the first pump.

In an embodiment the membrane filtration plant further comprises a second loop comprising a second membrane for filtering the feed and a second pump for circulating feed in the second loop wherein the system further comprises:
a second permeate sensor communicatively connected to the controller and configured for obtaining permeate data regarding a characteristic of a permeate through the second membrane, wherein the controller is further configured to:
subsequent to the steps A-F, control the second pump to flush the second loop,
receive permeate data from the second permeate sensor,
determine, based on the received permeate data, the characteristic of the permeate through the second membrane,
compare the characteristic of the feed with the characteristic of the permeate through the second membrane to determine a second permeate differences between the characteristic of the feed and the characteristic of the permeate through the second membrane,
compare the second permeate differences with the permeate threshold,
control the second pump to stop flushing the second loop based on whether the second permeate differences has exceeded the permeate threshold.

Consequently, the loops within the membrane filtration plant may be flushed in sequence after each other, thus assuring the loops are properly flushed. Although only a first loop and a second loop are mentioned, the approach with sequentially flushing loop within the membrane filtration plant is equally applicable if the membrane filtration plant were to comprise three loops, four loops or more.

The control of the second pump may comprise stopping the second pump, or lowering the powering output from the second pump. Preferably, the second pump and/or the first pump is controlled such that when flushing of the first loop is determined to be done, the power output of the second pump is higher than the first pump.

In an embodiment the downstream sensor is a conductivity sensor, a turbidity sensor, a temperature sensor, a pH-sensor, a refractometer, a flow sensor, a viscosity sensor, or a specific gravity sensor.

In embodiments where the system further comprises one or more permeate sensors and/or a retentate sensor, the one or more permeate sensors and/or the retentate sensor may be conductivity sensors, turbidity sensors, temperature sensors, pH-sensors, refractometers, flow sensors, viscosity sensors, or specific gravity sensors.

Preferably, the sensors comprised by the system are of the same sensor type, thus easing comparison between data obtained by the sensors. However, it is not necessary for the sensors to be of the same sensor type.

In a second aspect of the invention the invention relates to a membrane filtration plant comprising:
a permeate line,
a retentate line,
a feed line fluidly connected to the permeate line and the retentate line,
a downstream sensor configured for obtaining retentate data regarding a characteristic of a retentate or a permeate of the membrane filtration plant, and
a controller communicatively connected to the downstream sensor and configured to:
receive feed data regarding a characteristic of a feed of the membrane filtration plant,
determine, based on the received feed data, the characteristic of the feed,
receive downstream data from the downstream sensor,
determine, based on the received downstream data, the characteristic of the permeate or the retentate,
compare the characteristic of the feed with the characteristic of the permeate or the retentate to determine a downstream difference between the characteristic of the feed and the characteristic of the permeate or the retentate, and
compare the downstream difference with a downstream threshold,
control a process of the membrane filtration plant (100) based on whether the downstream difference has exceeded the downstream threshold.

The feed line may be any process line configured for fluidly transporting a feed. The membrane filtration plant may further comprise a feed tank, alternatively the membrane filtration plant may directly receive a feed from other processing equipment.

The retentate line may be any process line configured for fluidly transporting a retentate. The membrane filtration plant may further comprise a retentate tank, alternatively the membrane filtration plant may directly transport a retentate to other processing equipment.

The permeate line may be any process line configured for fluidly transporting a retentate. The membrane filtration plant may further comprise a retentate tank, alternatively the membrane filtration plant may directly transport a retentate to other processing equipment.

In a third aspect of the invention the invention relates to a method implemented by a controller for monitoring a fluid and controlling a process in a membrane filtration plant, wherein the method comprises the steps of:
receiving feed data, said feed data being regarding a characteristic of a feed of the membrane filtration plant,
determining, based on the received feed data, the characteristic of the feed,
receiving downstream data from a downstream sensor, said downstream data being regarding a characteristic of a retentate or a permeate of the membrane filtration plant,
determining, based on the received downstream data, the characteristic of the retentate or the permeate,
compare the characteristic of the feed with the characteristic of the retentate or the permeate to determine a downstream difference between the characteristic of the feed and the characteristic of the retentate or the permeate, and
compare the downstream difference with a downstream threshold,
control a process of the membrane filtration plant based on whether the downstream difference has exceeded the downstream threshold.

It is noted that the invention relates to all possible combinations of features recited in the claims, even across different aspects. Other objectives, features, and advantages of the present inventive concept will appear from the following detailed disclosure, from the attached claims as well as from the drawings. A feature described in relation to one of the aspects may also be incorporated in the other aspect, and the advantage of the feature is applicable to all aspects in which it is incorporated.

### BRIEF DESCRIPTION OF DRAWINGS

In the following description embodiments of the invention will be described with reference to the schematic drawings, in which:

FIG. 1 shows a block diagram of a membrane filtration plant according to an embodiment of the invention.

FIG. 2 shows a block diagram of a membrane filtration plant according to another embodiment of the invention.

FIG. 3 shows a block diagram of a membrane filtration plant according to yet another embodiment of the invention.

### DETAILED DESCRIPTION

The present invention will now be described more fully hereinafter with reference to the accompanying drawings, in which embodiments of the invention are shown. This invention may, however, be embodied in many different forms and should not be construed as limited to the embodiments set forth herein; rather, these embodiments are provided for thoroughness and completeness.

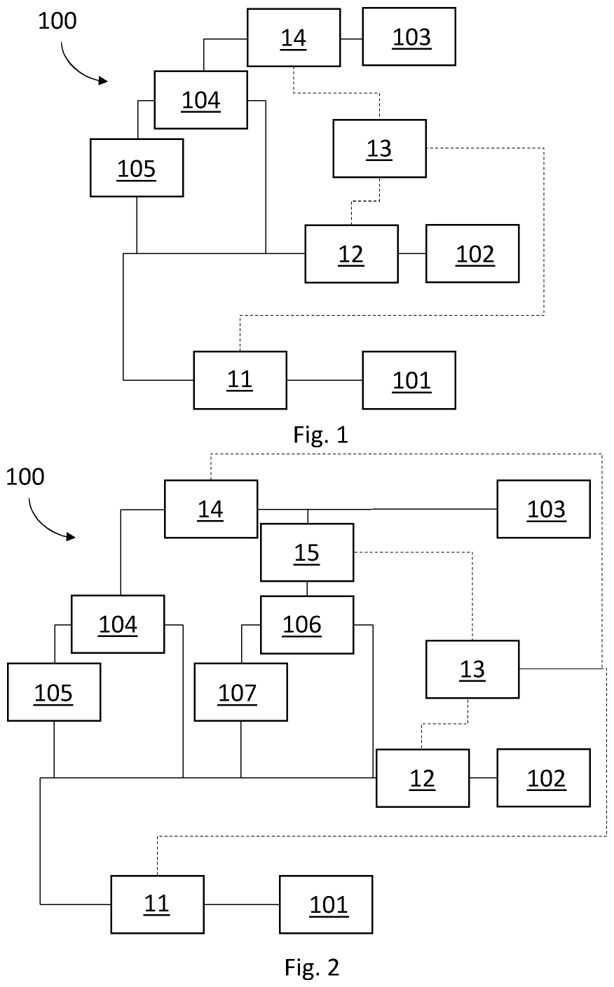

Referring initially to FIG. 1 depicting a block diagram of a membrane filtration plant 100 according to an embodiment of the invention. The membrane filtration plant 100 comprises a feed supply 101. The feed supply 101 may be a feed tank 101 intended for storing a feed and for letting a feed into the membrane filtration plant 100. Alternatively, the feed supply 101 may be a feed line fluidly connected to other processing equipment capable of delivering a feed to the membrane filtration plant 100. The feed supply 101 is fluidly connected to the rest of the membrane filtration plant 100 via one or more process lines. A process line may be a pipe or any other carrier suitable for transporting a fluid.

The membrane filtration plant 100 is provided with a system for monitoring a fluid and controlling a process. The system comprises one or more downstream sensors 12, 14 for obtaining downstream data regarding a characteristic of a permeate and/or a retentate of the membrane filtration plant 100 and a controller 13 is communicatively connected to the downstream sensor as will be described in further detail below with reference to specific implementations of the system.

In the embodiment described in relation to FIG. 1, the system further comprises a feed sensor 11 configured for obtaining feed data regarding a characteristic of the feed of the membrane filtration plant 100, the feed sensor 11 being communicatively connected to the controller 13. Alternatively, to having a feed sensor 11, data regarding a characteristic of the feed of the membrane filtration plant 100 may be inputted directly to the controller 13 by personnel.

Feed being fed from the feed supply 101 and into the membrane filtration plant 100 initially passes by the feed sensor 11. The feed sensor 11 is configured for obtaining feed data regarding a characteristic of a feed. The feed sensor 11 may be a conductivity sensor, a turbidity sensor, or a specific gravity sensor. The feed sensor 11 is configured to transmit obtained feed data to the controller 13. After the feed has passed the feed sensor 11 it arrives at the first loop. The first loop comprises a first pump 105 and a first membrane 104, the first pump 105 being for circulating feed in the first loop and the first membrane 104 for filtering the feed in the first loop.

The permeate which passes through the first membrane 104 passes by a permeate sensor 14, which constitutes one of one or more downstream sensors 12, 14. The permeate sensor 14 is configured for obtaining permeate data regarding a characteristic of the permeate. The permeate sensor 14 may be a conductivity sensor, a turbidity sensor, or a specific gravity sensor. The permeate sensor 14 is configured to transmit obtained permeate data to the controller 13. The permeate then passes into a permeate collector 103. The permeate collector 103 may be a permeate tank or a process line fluidly connected to other processing equipment capable of receiving the permeate from the membrane filtration plant 100. Retentate from the first loop passes by a retentate sensor 12 which constitutes yet another downstream sensor 12, 14. The retentate sensor 12 is configured for obtaining retentate data regarding a characteristic of a retentate. The retentate sensor 12 may be a conductivity sensor, a turbidity sensor, or a specific gravity sensor. The retentate sensor 12 is configured to transmit obtained retentate data to the controller 13. Retentate which has passed by the retentate sensor 12 is collected by a retentate collector 102. The retentate collector 102 may be a retentate tank or a process line fluidly connected to other processing equipment capable of receiving the retentate from the membrane filtration plant 100. Fluid collected by either the retentate collector 102 or the permeate collector 103 may be recirculated through the membrane filtration plant 100.

During a process, data is received by the controller 13 from the feed sensor 11, the retentate sensor 12, and the permeate sensor 14. The controller 13 then determines characteristics of the feed, the retentate, and the permeate, based on the received data from the sensors 11, 12, 14. The controller 13 may then control an on-going process based on comparisons between the determined characteristics.

To further elude the workings of the present invention an example is given where the process is a flush for flushing out membrane filtration plant 100 shown in FIG. 1. The controller 13 may initially control the first pump 105 to start flushing the first loop. The controller 13, after determining the characteristics of the feed, the retentate, and the permeate, based on the received data from the sensors 11, 12, 14, then compares the characteristic of the feed with the characteristic of the permeate to determine a permeate difference between the characteristic of the feed and the characteristic of the permeate. The controller 13 then compares the permeate difference to a permeate threshold. If the permeate difference exceeds the permeate threshold, the controller 13 controls the operation of the first pump 105. The controller 13 may stop the first pump 105 from further flushing the first loop, or the controller 13 may reduce the pumping power of the first pump 105. The first loop may have a minimum loop flush time associated with it, if the permeate difference exceeds the permeate threshold, but the minimum loop flush time has not passed, the controller 13 may wait until the minimum loop flush time has passed before it controls the operation of the first pump 105. After the controller 13 has controlled operation of the first pump 105, the controller 13 then compares the characteristic of the feed with the characteristic of the retentate to determine a retentate difference between the characteristic of the feed and the characteristic of the retentate. The controller 13 then compares the retentate difference to a retentate threshold. If the retentate difference exceeds the retentate threshold, the controller 13 controls the operation of the flush. The controller 13 may stop the flush. The controller 13 may start flushing with another fluid. The membrane filtration plant may have a minimum flush time associated with it, if the retentate difference exceeds the retentate threshold, but the minimum flush time has not passed, the controller 13 may wait until the minimum flush time has passed before it controls the process.

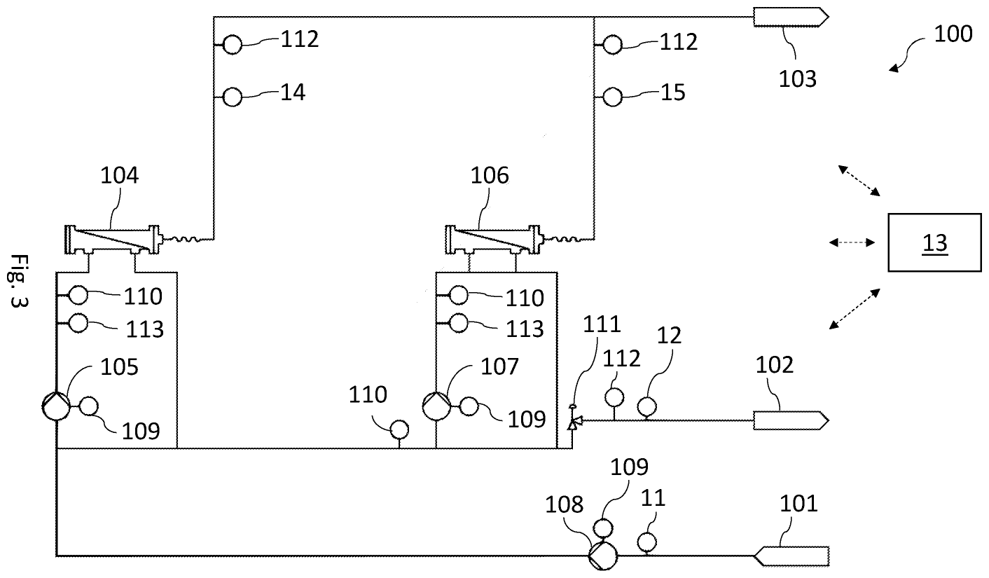

Referring to FIG. 2 depicting a block diagram of a membrane filtration plant 100 according to another embodiment of the invention. The membrane filtration plant 100 in FIG. 2 is similar to that of the one depicted in FIG. 1, however it differs in that the membrane filtration plant comprises a second loop. The second loop comprises a second pump 107 for circulating feed in the second loop, and a second membrane 106 for filtering the feed. Furthermore, a second permeate sensor 15 is arranged to obtain permeate data regarding a characteristic of the permeate through the second loop. The second permeate sensor 15 may be a conductivity sensor, a turbidity sensor, or a specific gravity sensor. The second permeate sensor 15 is configured to transmit obtained permeate data to the controller 13.

During a flushing process where the first loop is firstly flushed as described above in relation to FIG. 1, the controller 13 may subsequently be configured to control the second pump 107 to flush the second loop. The controller 13 then receives permeate data from the second permeate sensor 15, and determines a characteristic of the permeate through the second membrane 106. The characteristic of the permeate through the second membrane is then compared with the characteristic of the feed to determine a second permeate differences between the characteristic of the feed and the characteristic of the permeate through the second membrane 106. Then the controller 13 compares the second permeate differences with a permeate threshold. Based on whether the second permeate differences has exceeded the permeate threshold, the controller controls the second pump 107 to stop flushing the second loop.

Referring to FIG. 3 depicting a block diagram of a membrane filtration plant 100 according to yet another embodiment of the invention. Feed is supplied from a feed supply 101 which may be a feed tank or process line equipment arranged upstream of the membrane filtration plant 100. The feed initially passes a feed sensor 11 configured for obtaining feed data regarding a characteristic of the feed. The feed is pumped through the membrane filtration plant 100 by a feed pump 108. The feed initially passes a first loop. The first loop comprising a first pump 105 for pumping feed through the loop. The first loop comprises a temperature sensor 113 and a pressure sensor 110 for measuring a temperature and a flow pressure, respectively, of fluid being pumped through the first loop. Fluid in the first loop is filtered by a first membrane 104. The permeate which passes through the first membrane 104 passes through a first permeate sensor 14 configured for obtaining permeate data regarding a characteristic of the permeate. Subsequently, the permeate passes through a flow sensor 112. The flow sensor 112 may measure speed, and/or a volume of fluid passing by the flow sensor 112. Lastly, the permeate from the first loop flows into a permeate collector 103. The permeate collector 103 may be a permeate tank or other process equipment downstream from the membrane filtration plant 100. The feed may instead of flowing through the first loop flow towards a second loop, this may for example be achieved by lowering a power output of the first pump 105. Arranged in-between the first loop and the second loop is a pressure sensor 110. The second loop comprises a second pump 107 for pumping feed through the loop. The second loop comprises a temperature sensor 113 and a pressure sensor 110 for measuring a temperature and a flow pressure, respectively, of fluid being pumped through the second loop. Fluid in the second loop is filtered by a second membrane 106. The permeate which passes through the second membrane 106 passes through a second permeate sensor 15 configured for obtaining permeate data regarding a characteristic of the permeate. Subsequently, the permeate passes through a flow sensor 112. The flow sensor 112 may measure speed, and/or a volume of fluid passing by the flow sensor 112. Lastly, the permeate from the second loop flows into the permeate collector 103. The feed, which is not filtered through the membranes 104, 106, i.e. the retentate, flows by a valve 111 capable of adjusting a retentate flow towards a retentate collector 102. Before the retentate enters the retentate collector 102 it passes a flow sensor 112 and a retentate sensor 12 configured for obtaining retentate data regarding a characteristic of the retentate.

Connected to the pumps 105, 107, 108 of the membrane filtration plant 100 are speed controllers 109. The speed controllers 109 controls a power output of the pumps 105, 107, 108. The speed controllers 109 are communicatively connected to a controller 13, thus allowing the controller to control an output of the pumps 105, 107, 108 by sending one or more instructions to the speed controllers 109. The sensors 11, 110, 112, 113 are communicatively connected to the controller 13, thus allowing the controller to receive data regarding a fluid being circulated through the membrane filtration plant 100. The controller 13 may in response to receiving data from the sensors 11, 110, 112, 113 control an ongoing process, initiate a process, and/or terminate an on-going process. Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

What is claimed is:

1. System for monitoring a fluid and controlling a process in a membrane filtration plant, wherein the system comprises:
a downstream sensor configured for obtaining downstream data regarding a characteristic of a permeate or a retentate of the membrane filtration plant, and
a controller communicatively connected to the downstream sensor and configured to receive feed data regarding a characteristic of a feed of the membrane filtration plant,
determine, based on the received feed data, the characteristic of the feed,
receive downstream data from the downstream sensor,
determine, based on the received downstream data, the characteristic of the permeate or the retentate,
compare the characteristic of the feed with the characteristic of the permeate or the retentate to determine a downstream difference between the characteristic of the feed and the characteristic of the permeate or the retentate,
compare the downstream difference with a downstream threshold, and
control a process of the membrane filtration plant based on whether the downstream difference has exceeded the downstream threshold.

2. System according to claim 1, wherein the system further comprises a feed sensor configured for obtaining feed data regarding a characteristic of a feed of the membrane filtration plant, wherein the feed sensor is communicatively connected to the controller, and the controller is further configured to:
receive feed data from the feed sensor.

3. System according to claim 1, wherein the process is a flush.

4. System according to claim 3, wherein the controller is further configured to:
stop the flush when the downstream difference has exceeded the downstream threshold.

5. System according to claim 3, wherein the flush is at least carried out for a minimum flush time, and wherein the controller is further configured to:
determine whether the minimum flush time has passed, and
stop, if the minimum flush time has passed, the flush when the downstream difference has exceeded the downstream threshold.

6. System according to claim 3, wherein the process is maximumly carried out for a maximum flush time, and wherein the controller is further configured to:
determine whether the maximum flush time has passed, and
stop, if the maximum flush time has passed, the flush.

7. System according to claim 1, wherein the downstream sensor is a retentate sensor configured for obtaining downstream data regarding a characteristic of the retentate of the membrane filtration plant.

8. System according to claim 1, wherein the membrane filtration plant comprises one or more loops each comprising a membrane for filtering the feed and a pump for circulating feed in the associated loop, wherein the system further comprises:
one or more permeate sensors communicatively connected to the controller and configured for obtaining permeate data regarding a characteristic of a permeate through the one or more membranes, and
wherein the controller is further configured to:
receive permeate data from the one or more permeate sensors,
determine, based on the received permeate data, the one or more characteristics of the permeate through the one or more membranes,
compare the characteristic of the feed with the one or more characteristics of the permeate to determine one or more permeate differences between the characteristic of the feed and the characteristic of the retentate,
compare the one or more permeate differences with a permeate threshold, and
control the process of the membrane filtration plant based on whether the one or more permeate differences has exceeded the permeate threshold.

9. System according to claim 3, wherein the membrane filtration plant comprises a first loop comprising a first membrane for filtering the feed and a first pump for circulating feed in the first loop, wherein the system further comprises:
a first permeate sensor communicatively connected to the controller and configured for obtaining permeate data regarding a characteristic of a permeate through the first membrane, and wherein the controller is further configured to:
A. control the first pump to flush the first loop,
B. receive permeate data from the first permeate sensor,
C. determine, based on the received permeate data, the characteristic of the permeate through the first membrane,
D. compare the characteristic of the feed with the characteristic of the permeate through the first membrane to determine a first permeate differences between the characteristic of the feed and the characteristic of the permeate through the first membrane,
E. compare the first permeate differences with the permeate threshold, and
F. control the first pump to stop flushing the first loop based on whether the first permeate differences has exceeded the permeate threshold.

10. System according to claim 9, wherein the membrane filtration plant further comprises a second loop comprising a second membrane for filtering the feed and a second pump for circulating feed in the second loop wherein the system further comprises:
a second permeate sensor communicatively connected to the controller and configured for obtaining permeate data regarding a characteristic of a permeate through the second membrane, wherein the controller is further configured to:
subsequent to the steps A-F, control the second pump to flush the second loop,
receive permeate data from the second permeate sensor,
determine, based on the received permeate data, the characteristic of the permeate through the second membrane,
compare the characteristic of the feed with the characteristic of the permeate through the second membrane to determine a second permeate differences between the characteristic of the feed and the characteristic of the permeate through the second membrane,
compare the second permeate differences with the permeate threshold, and
control the second pump to stop flushing the second loop based on whether the second permeate differences has exceeded the permeate threshold.

11. System according to claim 1, wherein the downstream sensor is a conductivity sensor, a turbidity sensor, or a specific gravity sensor.

12. Membrane filtration plant comprising:
a permeate line,
a retentate line,
a feed line fluidly connected to the permeate line and the retentate line,
a downstream sensor configured for obtaining retentate data regarding a characteristic of a retentate or a permeate of the membrane filtration plant, and
a controller communicatively connected to the downstream sensor and configured to:
receive feed data regarding a characteristic of a feed of the membrane filtration plant,
determine, based on the received feed data, the characteristic of the feed,
receive downstream data from the downstream sensor,
determine, based on the received downstream data, the characteristic of the permeate or the retentate,
compare the characteristic of the feed with the characteristic of the permeate or the retentate to determine a downstream difference between the characteristic of the feed and the characteristic of the permeate or the retentate,
compare the downstream difference with a downstream threshold, and
control a process of the membrane filtration plant based on whether the downstream difference has exceeded the downstream threshold.

13. A method implemented by a controller for monitoring a fluid and controlling a process in a membrane filtration plant, wherein the method comprises the steps of:
receiving feed data, the feed data being regarding a characteristic of a feed of the membrane filtration plant,
determining, based on the received feed data, the characteristic of the feed,
receiving downstream data from a downstream sensor, the downstream data being regarding a characteristic of a retentate or a permeate of the membrane filtration plant,
determining, based on the received downstream data, the characteristic of the retentate or the permeate,
compare the characteristic of the feed with the characteristic of the retentate to determine a retentate difference between the characteristic of the feed and the characteristic of the retentate,
compare the retentate difference with a retentate threshold, and
control a process of the membrane filtration plant based on whether the retentate difference has exceeded the retentate threshold.
